(19) United States
(12) Patent Application Publication
(10) Pub. No.: US 2016/0314689 A1
(43) Pub. Date: Oct. 27, 2016

(54) Traffic Signal Sequence Alert

(71) Applicant: Charles William Priest, III, Jacksonville, FL (US)

(72) Inventor: Charles William Priest, III, Jacksonville, FL (US)

(21) Appl. No.: 14/692,788

(22) Filed: Apr. 22, 2015

(51) Int. Cl. G08G 1/0967; G08G 1/095

(52) U.S. Cl. CPC G08G 1/096783; G08G 1/095

(57) ABSTRACT

This invention is a device that alerts the driver of a vehicle located at or near a traffic signal-controlled intersection that the red light has changed to green. The alert takes place by either audible, visual, or tactile means.

The invention is to be powered by the automobile electrical system, either through the OBD2 port or through the 12V accessory port.

### BACKGROUND

1. Field of the Invention

This invention relates to the field of automobile vision, sensors, and traffic signal detection. More specifically, this invention is a device mounted within the vehicle to alert the driver of a green traffic signal.

2. Description of the Related Art

In this day there are many forms of vehicle sensing technologies which work to the Other systems allow for obstacle avoidance, lane keeping assistance, and adaptive cruise control by using suites of sensors including cameras, radar, lidar, and global positioning information. Some automobiles are so equipped with automation and sensors that they no longer need the input benefit of driver safety and awareness. Some of these technologies allow the automatic dimming of headlights based on sensor data acquired by cameras, radar, and even sonar, of a driver in order to navigate successfully through city streets and highways. In one scheme, radar, lidar, and cameras are used to alert the driver that the vehicle is nearing the borders of the lane by vibrating the driver's seat.

In another scheme, a CMOS camera is used with other sensors to identify and read traffic signs on the side of the road. The purpose is to automatically adjust headlight positioning or brightness, vehicle speed, or vehicle direction.

In today's world, there are numerous distractions to prevent a driver from being aware of a traffic signal that has turned green. It is quite common to observe a driver texting or otherwise distracted by personal electronics while stopped at a traffic signal and fail to notice that the signal has turned from red to green. It is also common for this action to result in horns being heard and following traffic to miss the green signal as the distracted driver accelerates through the now yellow light. This invention intends to alert the driver of a green traffic signal while the vehicle is stopped or moving slowly.

### SUMMARY

The present invention is an electronic device that is mounted on the inside of the windshield of a vehicle and alerts the driver either audibly, visually, or by tactile feedback, that a traffic signal has changed from red to green. The invention is intended to make drivers aware that a previously red traffic signal has changed to green so that they will proceed through the intersection.

Normal use of the invention would take the following form; The invention is mounted to the inside of the vehicle in view of objects in front of the vehicle. It is mounted by a bracket, preferably to the inside of the windshield and in a slightly upward angle so that it may view traffic signals. The invention would be plugged into the 12V accessory port of the vehicle. Upon stopping at an intersection with a red traffic signal, the invention would then detect the red traffic signal. It then would enter a loop wherein it is expecting a green signal. When the traffic signal changes to green, the invention sends out an audible signal to the driver, notifying him or her that the signal is now green and they can proceed through the intersection.

### BRIEF DESCRIPTION OF THE DRAWINGS

FIG. 1. shows a perspective view of the invention in an assembled state but without the mounting bracket.

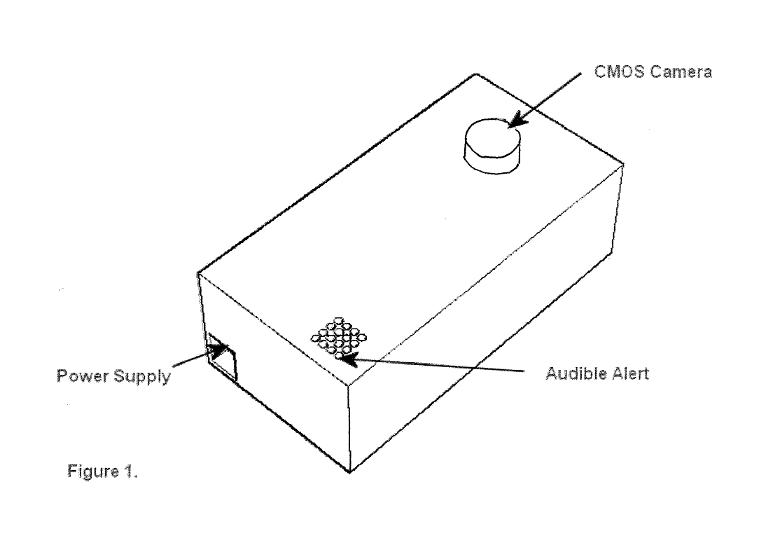

### DETAILED DESCRIPTION

The invention is comprised of a CMOS camera, microcontroller, global positioning receiver, vehicle onboard diagnostics II bridge (OBD2) and audible, visual or tactile alert. The camera is available off-the-shelf and is outfitted with color and object tracking software. It is set to recognize the specific hues of green and red that are found in lighted traffic signals. It sends the detected hues to the microcontroller. The OBD2 adapter makes available and translates vehicle speed information from the vehicle computer (ECU) to the microcontroller, as well as power for the entire system. The GPS receiver sends GPS coordinate data to the microcontroller. Software in the microcontroller first receives the object and hue information from the camera. If it detects a red light, it checks the speed data supplied from the OBD2 bridge or computes the speed from the OPS data. If the speed is determined to be below a set maximum, the microcontroller will interrogate the camera for the appropriate green hue. Once the green hue is indicated to the microcontroller, it then interrogates the OBD2 bridge and GPS receiver to determine speed. If the speed is still below a set maximum, the microcontroller sends a voltage and current to the audible alert, thereby notifying the driver that the light has changed to green. The camera, microcontroller, GPS receiver, and audible or tactile alert is typically mounted in one enclosure and secured to the windshield of the vehicle by an adjustable mount consisting of a metal bracket and suction cups or strap for securing to the visor or rear view mirror. The mounting bracket is constructed in such a way as to allow the camera to be adjusted angularly so that it gets full view of the traffic signals.

1. A driver traffic signal green light alert device.

2. A device as claimed in item 1, utilizing a “smart” or CMOS camera, microcontroller, and GPS receiver and audible alert.

3. A portable driver traffic signal green light alert device with audible alert.

4. A device as claimed in item 3, utilizing a “smart” or CMOS camera, microcontroller, and GPS receiver.
